(19) United States
(12) Patent Application Publication
(10) Pub. No.: US 2024/0173684 A1
(43) Pub. Date: May 30, 2024

(54) APPARATUS AND METHOD FOR HOTSPOT DETECTION IN A TUBE BUNDLE REACTOR

(71) Applicant: BASF SE, Ludwigshafen am Rhein (DE)

(72) Inventors: Gerhard OLBERT, Ludwigshafen am Rhein (DE); Torsten MATTKE, Ludwigshafen am Rhein (DE); Jens FERBITZ, Ludwigshafen am Rhein (DE); Koenraad VANDEWALLE, Antwerp (BE); Kai THIELE, Antwerp (BE); Peter VAN DEN ABEEL, Antwerp (BE)

(21) Appl. No.: 18/282,574

(22) PCT Filed: Mar. 18, 2022
(86) PCT No.: PCT/EP2022/057139

§ 371 Date: Sep. 18, 2023

(30) Foreign Application Priority Data
Mar. 19, 2021 (EP) 21163669.1

(51) Int. Cl. B01J 8/06

(52) U.S. Cl. CPC B01J 8/065; B01J 8/067; B01J 2208/00053; B01J 2208/00088; B01J 2208/00256; B01J 2208/021; B01J 2208/065

(57) ABSTRACT

Chemical reactor comprising an educt space with inlet means for feeding at least one educt stream into said space: a product space with outlet means for removing at least one product stream from said space: a plurality of parallel tubes extending from the educt space to the product space in an axial direction, forming a tube bundle, wherein the tubes comprise at least one heterogeneous catalyst: a cooling liquid space surrounding at least a section of the tube bundle, wherein said space has an inlet and an outlet spaced from the inlet at least in the axial direction, and wherein the cooling liquid space defines a cooling liquid flow path between inlet and outlet: n cooling liquid temperature measuring devices MD(i), i=1 . . . n, n>2, inside the cooling liquid space, wherein MD(i+1), is located upstream of MD(i) in the cooling liquid flow path.

The present invention relates to a chemical reactor comprising a bundle of tubes being filled with a heterogeneous catalyst, to a chemical production unit comprising such a chemical reactor and a temperature monitoring means, and to a method for operating such a chemical reactor or such a chemical production unit.

Catalytic reactions with a strong heat tone are widespread in the chemical industry. Especially exothermal reactions belong to this category. One example of such a reaction is chlorination, for example the synthesis of phosgene from carbon monoxide and chlorine.

In order to handle the generated heat these types of reactions are usually performed in cooled reactors. Often, tube bundle reactors are used wherein the catalyst is located in the tubes (also referred to as reaction tubes) and a suitable cooling liquid flows through a cooling liquid space surrounding at least a section of the bundle of the tubes along a cooling liquid flow path. Typically, the tubes are all parallel to each other and extend in an axial direction from an educt space to a product space. The axial direction is often the vertical direction because this eases filling the tube with and discharging them from catalyst. A generic chemical reactor is described in WO 03/072237 A1.

In case of reactions with a strong heat tone (especially exothermal reactions), often a distinct hotspot evolves. This means that most of the reaction is not spread along a substantive length of the tubes, but takes place in a relatively short section of the tubes. In many types of those reactions, the used catalyst deactivates over time due to chemical and/or thermal influences. Because of this deactivation, the hotspot moves away from the educt space towards the product space. In these cases, the catalyst has to be changed or re-activated after a certain operation time before the hotspot comes too close to the educt space. If all parameters (like the used catalyst, the educt quality and composition, the pressure and temperature) were perfectly known and constant, the usable operation time would be constant and one would know after which period of time the catalyst needs to be changed. But in industrial practice these parameters are often not sufficiently constant and so the usable operation time can change.

Of course, it is desired to change or reactivate the catalyst as rarely as possible because changing or reactivating the catalyst leads to a production stop. So, an analytic should be installed from whose results conclusions about the state of the catalyst can be drawn such that the remaining operation time can be estimated and a production stop can be planned. One possibility for achieving this is to analyze the products generated by the reaction, but especially online-analyzes are often very complex.

Another attempt is to measure the temperature profiles inside the tubes so that the position and the movement of the hotspot can be observed. For doing so, it is known to provide a so-called temperature tube inside at least one of the reaction tubes. This temperature tube is a multi-thermo-element having a plurality of axially spaced temperature measuring spots. So, the temperature inside the respective reaction tube is directly measured at these axial positions such that a temperature profile within this reaction tube is obtained. The spatial resolution of this temperature profile depends on the distances between the temperature measuring spots. Since it is crucial for these kinds of reactors that all tubes “see” the same conditions, it is assumed that the reaction takes place in an essentially identical way in all tubes, such that knowing the position of the hotspot in one tube (or several tube in order to have a redundancy or a statistic) is sufficient, since of course the hotspot is positioned in all tubes at the same axial position if the above given assumption is correct.

Although this direct temperature measurement has several advantages over the aforementioned analyzing method, it also has several drawbacks.

One drawback is that the temperature tube is subjected to high temperatures and often also to reactive chemicals such that they often have only a limited lifetime and/or need to be maintained frequently. Additionally, such temperature tubes which can withstand high temperatures as well as aggressive chemicals at least for a reasonable period of time are often expensive.

Another drawback is that despite the fact that the temperature tube is located inside a tube of the bundle of tubes and thus very close to catalyst, it is still not easy to interpret the measured temperature of the hotspot because large temperature differences can occur between the catalyst phase and the phase of the flowing educt-product-fluid. The measured temperature is somewhere between the temperature of those two phases. Further, the axial heat conduction of the thermo tube itself affects the measurement.

Further, the thermo tube obstructs an even filling of the tube with catalyst.

Maybe the most relevant drawback is that the presence of a thermo tube can affect the state of the catalyst, especially because it can disturb the filling of the catalyst. This effect usually increases with the decrease of the ratio between the diameter of the reaction tube to the diameter of the thermo tube. So, the case can occur that just the tube in which the temperature measurement takes place is not representative for the remaining tubes of the bundle of tubes—the measurement itself destroys the equality of this tube compared to the remaining tubes. Providing each tube of the bundles of tubes with a thermo tube would be a solution for this problem, but extremely costly.

It is therefore an object of the invention to provide an improved chemical reactor that allows a sufficiently precise location of a hotspot in the bundle of tubes and avoids the above described drawbacks.

According to the invention, the temperature inside the tubes is measured not directly, but indirectly, namely by measuring the temperature of the cooling liquid at at least two spaced positions of the cooling liquid flow path, such that a temperature profile of the cooling liquid along the cooling liquid flow path is obtained. As has been mentioned, there is usually a hotspot in each of the tubes when the reactor is operating and theses hotspots are located essentially at one axial position of the tubes (such that one can also speak of one hotspot). As a consequence, the heat transfer from the tubes to the cooling liquid is not spatially uniform along the flow path of the cooling liquid such that not only the tubes but also the flowing cooling liquid in the cooling liquid flow path shows a spatial temperature profile. By measuring this spatial temperature profile of the flowing cooling liquid by means of at least two—preferably more than three—temperature measuring devices, the position of the hotspot in the tubes can at least roughly be determined. Knowing the axial position of the hotspot at least roughly is often enough for estimating the time remaining before an exchange of the catalyst is necessary. So, by a rather simple measurement of the temperature of the cooling liquid at at least two positions of the cooling liquid flow path the temperature measurement inside the tubes can be avoided. Since the maximum temperature of the cooling liquid (usually water) is substantially lower than the maximum temperature inside the tubes and the cooling liquid is usually not corrosive, cost-effective temperature measuring devices can be used.

When the hotspot inside the tubes moves along the axial length of the tubes, the spatial temperature profile of the cooling liquid along the cooling liquid flow path also changes. So, also the dynamic of the hotspot can be observed, such that the remaining operation time can be predicted.

Therefore, the present invention relates to a chemical reactor comprising
(i) an educt space and a product space;
(ii) educt space inlet means for feeding an educt stream into the educt space, and product space outlet means for removing a product stream from the product space;
(iii) a plurality of tubes extending parallel to one another from the educt space to the product space according to (i), in an axial direction forming a tube bundle, wherein the tubes are at least partially filled with a heterogeneous catalyst;
(iv) a cooling liquid space surrounding at least a section of the tube bundle according to (iii), wherein the cooling liquid space has a cooling liquid inlet and a cooling liquid outlet being spaced from the cooling liquid inlet at least in the axial direction, and wherein the cooling liquid space defines a cooling liquid flow path between the cooling liquid inlet and the cooling liquid outlet;
(v) n temperature measuring devices MD(i), i=1 . . . n, n>2, located inside the cooling liquid space, wherein MD(i+1), i<n, is located upstream of MD(i) in the cooling liquid flow path, for measuring the respective temperatures T(i) of the cooling liquid.

The invention is especially useful for chemical reactors that have a basic structure as shown in generic WO 03/072237 A1 meaning that the cooling liquid flow path is unbranched and the cooling liquid space comprises m main sections MS(j), j=1 . . . m, m≥2, wherein in a main section MS(j), the cooling liquid has an average main flow direction f(j), wherein f(j) is essentially perpendicular to the axial direction of the tube bundle, and wherein the cooling liquid space further comprises m−1 deflection sections DS(j), j=1 . . . m−1, wherein a deflection section DS(j) connects two adjacent main sections MS(j) and MS(j+1), j<m, wherein in a deflection section DS(j), the flow direction f(j) is deflected so that the flow direction f(j+1) is essentially opposite to f(j).

Usually, the hotspot in the tubes is located in one or two of the main sections MS(j) and therefore, the rises of the temperature of the cooling liquid flowing through a main section in which the hotspot is located or in an adjacent section, is relatively strong such that the hotspot can easily be located with a sufficient precision.

The temperature difference between two temperature measuring devices is maximal when these two temperature measuring devices are located at different ends of the main section MS(j) in which the heat transfer from the tubes is maximal, meaning in the deflection sections DS(j). Since the hotspot usually moves through several main sections, it is preferred that each temperature measuring device MD(i) is located in a deflection section DS(j) and it is especially preferred that in each deflection section DS(j), a temperature measuring device MD(i) is located, such that the amount of information is maximized.

Usually, the reactor has one more main sections than it has deflection sections, so n=m−1.

In order to achieve an optimum length of the flow path, the number of main sections is preferably between 5 and 20, i.e. 5≤m≤20.

As described in generic WO 03/072237 A1, the tube bundle preferably extends through the main sections MS(j), and in order to make sure that the environment for each of the tubes of the bundle is essentially the same, it is usually preferred that the tube bundle does not extend through the deflection sections DS(j).

As has already been mentioned, the reactor layout can be essentially the same as described in generic WO 03/072237 A1.

The invention can also be applied to other types of cooled bundle tube reactors, for example cooled bundle tube reactors of the radial type. The cooling liquid flow path in reactors of this type is branched and the cooling liquid space comprises additionally to m main sections MS(j), j=1 . . . m, m≥2 and k deflection sections DS(j), j=1 . . . k, I connection sections CS(j), j=1 . . . I connecting two adjacent main sections. In this case, the deflection sections are usually annular-shaped and the connection sections are located axially in the center of the reactor. Two adjacent main sections are connected to one another either by a connection section or by a deflection section in an alternating pattern such that the cooling liquid flows alternating radially inward and radially outward. In cooled bundle tube reactors, usually the following applies: I=k+2 and m=21. As in the reactor type described above, the tubes usually extend exclusively through the main sections.

As in the above described reactor type, the temperature measuring devices are preferably located in the deflection sections, especially only in the deflection sections. In this case, the temperature difference measured by two neighbored temperature measuring devices is the temperature difference of the cooling liquid after having passed two successive main sections. Thus, the spatial resolution is reduced in relation to the above described case.

In both types of the reactor types described above, the tube bundle extends usually between the educt space and the product space.

Although such reactors are not very common, it would possible to apply the invention to a reactor whose flow path is in sections of the radial type and in sections of the type described in WO 03/072237 A1.

The flow direction of the cooling liquid can be in counterstream configuration or opposite to a counterstream configuration.

Typically, the tube bundle preferably consists of from 100 to 100,000, more preferably of from 500 to 50,000, more preferably of from 1000 to 30,000 tubes. Preferably, the axial direction according to (iii) is an essentially vertical direction.

The skilled person can detect a hotspot by the temperature measurements of the cooling liquid, in the present case by using n temperature measuring devices MD(i) inside the cooling liquid space of a chemical reactor according to the present invention. The comparison of the temperatures determined by the n temperature measuring devices MD(i) will permit to designate a maximum temperature difference which reflects the maximal heat transfer from the bundle of tubes to the cooling liquid which indicates the presence of the hotspot. In order to localize the position of the hotspot, the skilled person has to find the two temperature measurement devices between which a maximum rise of temperature is found and thus the hotspot. For doing so, the skilled person can calculate the temperature differences ΔT(i)=T(i)−T(i+1), i=1 . . . n−1, based on the temperatures T(i) measured according to (c), and determine i for which ΔT(i) exhibits its maximum. Said i is defined as i(max). This calculating is preferably carried out automatically by the temperature monitoring means.

Thus, it is preferred that the measurement of the respective temperatures T(i) of the cooling liquid by means of each of the n temperature measuring devices MD(i) according to (v) is simultaneous, at least during subjecting the educt stream to exothermic reaction conditions in the tubes of the tube bundle obtaining a product stream, wherein the reaction conditions comprise contacting the educt stream with the heterogeneous catalyst with which the tubes of the tube bundles are at least partially filled, and whereby a set S(T(i)) of n temperatures T(i) can be obtained.

In the case where the n temperature measuring devices MD(i) simultaneously measure the n temperatures T(i) of the cooling liquid by means of each of the n temperature measuring devices MD(i) according to (v), at least during subjecting the educt stream to exothermic reaction conditions in the tubes of the tube bundle obtaining a product stream, wherein the reaction conditions comprise contacting the educt stream with the heterogeneous catalyst with which the tubes of the tube bundles are at least partially filled, and whereby a set S(T(i)) of n temperatures T(i) can be obtained, it is preferred that during subjecting the educt stream to exothermic reaction conditions, the temperature differences ΔT(i)=T(i)−T(i+1), i=1 . . . n−1, are calculated based on the temperatures T(i) measured, and wherein i is determined for which ΔT(i) exhibits its maximum, said i being defined as i(max), wherein said calculation is preferably carried out by the temperature monitoring means as defined in any one of the embodiments disclosed herein.

Further in the case where the n temperature measuring devices MD(i) simultaneously measure the n temperatures T(i) of the cooling liquid by means of each of the n temperature measuring devices MD(i) according to (v), at least during subjecting the educt stream to exothermic reaction conditions in the tubes of the tube bundle obtaining a product stream, wherein the reaction conditions comprise contacting the educt stream with the heterogeneous catalyst with which the tubes of the tube bundles are at least partially filled, and whereby a set S(T(i)) of n temperatures T(i) can be obtained, it is preferred that at least during subjecting the at least one educt stream to exothermic reaction conditions the n temperatures T(i) of the cooling liquid are measured at consecutive times t(k), obtaining k temperatures T(i), Tₖ(i), k sets of the n temperatures T(i), Sₖ(T(i)), and, for each Sₖ(T(i)), a respective iₖ(max).

Therefore, the skilled person can detect a hotspot by determining a maximum of ΔT(i) by means of the n temperature measuring devices MD(i) according to (v). In particular, the skilled person can detect a hotspot by determining a maximum of ΔT(i) by means of the n temperature measuring devices MD(i) according to (v) which can simultaneously measure the n temperatures T(i) of the cooling liquid, at least during subjecting the educt stream to exothermic reaction conditions in the tubes of the tube bundle obtaining a product stream, wherein the reaction conditions comprise contacting the educt stream with the heterogeneous catalyst with which the tubes of the tube bundles are at least partially filled, and whereby a set S(T(i)) of n temperatures T(i) can be obtained.

It is preferred that the temperature monitoring takes place in an automated process. For this purpose a temperature monitoring means for receiving and monitoring signals from the temperature measuring devices MD(i) can be provided. This temperature monitoring means and the chemical reactor form a chemical production unit. The temperature monitoring means usually comprises a signal processing means and a calculating means.

Thus, the temperature measuring devices MD(i) permit to determine the temperatures T(i) which can then be processed in the temperature monitoring means. Further, the temperature monitoring means can be used for performing calculations based on the temperatures T(i) received as signals from the temperature measuring devices MD(i). The results of said calculations can be output via an information output, which can be a monitor or a monitoring system of a chemical plant. In this context, it is preferred that the temperature monitoring means are located in the deflection sections DS(1). Therefore, the position and thus also the velocity of the axial movement of a hotspot can be determined only by performing simple measurements of the temperature of the cooling liquid.

As has already been described, the typical use of the inventive reactor is in the production of a chemical compound in an exothermic reaction. It is suitable for many different processes, the most relevant are the following: Processes in which the reaction is an oxidation or partial oxidation, processes in which the reaction is a hydrogenation, and processes in which the reaction is a chlorination. In case of an oxidation or partial oxidation, the chemical compound can especially be acrolein, acrylic acid, phthalic acid anhydride, maleic acid anhydride, ethylene oxide, glyoxal or chlorine (Deacon process). In case of a chlorination, the chemical compound is preferably phosgene.

The heterogeneous catalyst with which the tubes are at least partially filled may have any conceivable geometry such as strands, spheres, rings, tablets and the like. Further, depending on the individual requirements of the respective exothermic chemical reaction, the catalyst may consist of catalytically active material or may comprise, in addition to catalytically active material, preferably inert material such as an inert support. Generally, it is conceivable that the tubes are at least partially filled with a mixture of two or more heterogeneous catalysts. The term “at least partially filled” as used in this context of the present invention relates to tubes which are either completely filled over their entire length or filled, e.g., with inert material, at their upper and/or lower end and filled with heterogeneous catalyst in the portions of the tubes which are surrounded by the cooling liquid in the cooling liquid space when the inventive reactor is in operation. In particular in case the chemical compound is phosgene, e.g. prepared using an educt stream comprising CO and Cl₂, the heterogeneous catalyst may be preferably a carbon-based catalyst of which from 50 to 100 weight-% such as from 75 to 100 weight-% or from 90 to 100 weight-% or from 99 to 100 weight-% consist of carbon, said catalyst preferably being a porous carbon-based catalyst, more preferably a carbon-based catalyst comprising micropores and mesopores, wherein said micropores have a pore diameter, determined according to DIN 66135-2, of less than 2 nm and wherein said mesopores have a pore diameter, determined according to DIN 66134, in the range of from 2 to 50 nm.

In a conventional use of the inventive reactor, educt is fed into the educt space, flows into the tubes of the bundle of tubes where it reacts at least partially, and product leaves the tubes and reaches the product space from which it is removed. Simultaneously, the tubes are cooled by means of the cooling liquid being fed into the cooling liquid inlet and removed from the cooling liquid outlet. According to the invention the temperature of the cooling liquid is measured at at least two locations by means of the temperature measuring devices.

Therefore, the method for operating the inventive chemical reactor comprises:
(a) preparing a product stream in a heterogeneously catalyzed exothermic reaction, comprising
   (a.1) feeding an educt stream via the educt space inlet means according to (ii) into educt space according to (i) and into the tubes of the tube bundle according to (iii);
   (a.2) subjecting the educt stream to exothermic reaction conditions in the tubes of the tube bundle obtaining a product stream, the reaction conditions comprising contacting the educt stream with the heterogeneous catalyst with which the tubes of the tube bundles are at least partially filled;
   (a.3) removing the product stream from the educt space according to (i) via the product space outlet means according to (ii);
(b) cooling, at least during subjecting the stream to exothermic reaction conditions according to (a.2), the tube bundle with a cooling liquid stream, said cooling comprising feeding the cooling liquid stream via the cooling liquid inlet into the cooling liquid space according to (iv), passing the cooling liquid stream through the cooling liquid space, and removing the cooling liquid stream from the cooling liquid space via the cooling liquid outlet according to (iv);
(c) simultaneously measuring the n temperatures T(i) of the cooling liquid by means of each of the n temperature measuring devices MD(i) according to (v), at least during subjecting the educt stream to exothermic reaction conditions according to (a.2), obtaining a set S(T(i)) of n temperatures T(i).

In particular as far as a preparation of phosgene from CO and Cl₂ is concerned, the present invention relates to a method for operating the inventive chemical reactor which comprises:
(a) preparing a product stream comprising phosgene in a heterogeneously catalyzed exothermic reaction, comprising
   (a.1) feeding an educt stream comprising CO and Cl₂ via the educt space inlet means according to (ii) into educt space according to (i) and into the tubes of the tube bundle according to (iii);
   (a.2) subjecting the educt stream to exothermic reaction conditions in the tubes of the tube bundle obtaining a product stream comprising phosgene, the reaction conditions comprising contacting the educt stream with the heterogeneous catalyst with which the tubes of the tube bundles are at least partially filled, preferably with a carbon-based catalyst as described hereinabove;
   (a.3) removing the product stream comprising phosgene from the educt space according to (i) via the product space outlet means according to (ii);
(b) cooling, at least during subjecting the stream to exothermic reaction conditions according to (a.2), the tube bundle with a cooling liquid stream, said cooling comprising feeding the cooling liquid stream via the cooling liquid inlet into the cooling liquid space according to (iv), passing the cooling liquid stream through the cooling liquid space, and removing the cooling liquid stream from the cooling liquid space via the cooling liquid outlet according to (iv);
(c) simultaneously measuring the n temperatures T(i) of the cooling liquid by means of each of the n temperature measuring devices MD(i) according to (v), at least during subjecting the educt stream comprising CO and Cl₂ to exothermic reaction conditions according to (a.2), obtaining a set S(T(i)) of n temperatures T(i).

The main aim of the temperature measurements of the cooling liquid is to localize the axial position of the hotspot of the catalytic reaction. It turned out that the rise of the temperature of the cooling liquid usually has a maximum between two temperature measuring devices, such that an axial position of the maximal heat transfer from the bundle of tubes to the cooling liquid can be identified, and that this axial position correlates with the axial position of the hotspot. In order to find these two temperature measurement devices and thus the hotspot, one can calculate the temperature differences ΔT(i)=T(i)−T(i+1), i=1 . . . n−1, based on the temperatures T(i) measured according to (c), and determine i for which ΔT(i) exhibits its maximum. Said i is defined as i(max). This calculating is preferably carried out automatically by the temperature monitoring means.

Of course, it is usually not sufficient to know the axial location of the hotspot at one point in time, rather one also needs to observe its movement. So, it is preferred to measure the n temperatures T(i) of the cooling liquid consecutive times t(k), thus obtaining k temperatures T(i), Tₖ(i), k sets of the n temperatures T(i), Sₖ(T(i)), and to calculate, for each Sₖ(T(i)), a respective iₖ(max). In a subsequent step one can determine iₖ(max) as a function of t(k).

As has been mentioned, the key interest is detecting the hotspot of a heterogeneously catalyzed exothermic reaction in a tube bundle reactor, especially for determining the change of the position of the hotspot of a heterogeneously catalyzed exothermic reaction in a tube bundle reactor over time.

By tracking the hotspot, one usually also tracks the deactivation of the heterogeneous catalyst in an exothermic reaction in the tubes of a tube bundle reactor, because usually the portion of the heterogeneous catalyst upstream of the hotspot is deactivated.

Therefore, the present invention further relates to a use of the chemical reactor according to the present invention and as disclosed herein or of the chemical production unit according to the present invention and as disclosed herein or of the method according to the present invention and as disclosed herein for detecting a hotspot of a heterogeneously catalyzed exothermic reaction in a tube bundle reactor, preferably for determining the change of the position of a hotspot of a heterogeneously catalyzed exothermic reaction in a tube bundle reactor.

It is preferred that the use is for tracking the deactivation of a heterogeneous catalyst in an exothermic reaction in the tubes of a tube bundle reactor.

In the case where the chemical reactor or the chemical production unit according to the present invention is used, it is preferred that the n temperature measuring devices MD(i) simultaneously measure the n temperatures T(i) of the cooling liquid by means of each of the n temperature measuring devices MD(i) according to (v), at least during subjecting the educt stream to exothermic reaction conditions in the tubes of the tube bundle obtaining a product stream, wherein the reaction conditions comprise contacting the educt stream with the heterogeneous catalyst with which the tubes of the tube bundles are at least partially filled, and whereby a set S(T(i)) of n temperatures T(i) can be obtained. In this context, it is preferred that during subjecting the educt stream to exothermic reaction conditions, the temperature differences ΔT(i)=T(i)−T(i+1), i=1 . . . n−1, are calculated based on the temperatures T(i) measured, and wherein i is determined for which ΔT(i) exhibits its maximum, said i being defined as i(max), wherein said calculation is preferably carried out by the temperature monitoring means as defined in any one of the embodiments disclosed herein. Further, it is preferred in this context that at least during subjecting the at least one educt stream to exothermic reaction conditions the n temperatures T(i) of the cooling liquid are measured at consecutive times t(k), obtaining k temperatures T(i), Tₖ(i), k sets of the n temperatures T(i), Sₖ(T(i)), and, for each Sₖ(T(i)), a respective iₖ(max).

The present invention is further illustrated by the following set of embodiments and combinations of embodiments resulting from the dependencies and back-references as indicated. In particular, it is noted that in each instance where a range of embodiments is mentioned, for example in the context of a term such as “The chemical reactor of any one of embodiments 1 to 3”, every embodiment in this range is meant to be explicitly disclosed for the skilled person, i.e. the wording of this term is to be understood by the skilled person as being synonymous to “The chemical reactor of any one of embodiments 1, 2 and 3”. Further, it is explicitly noted that the following set of embodiments is not the set of claims determining the extent of protection, but represents a suitably structured part of the description directed to general and preferred aspects of the present invention.
1. A chemical reactor comprising
   (i) an educt space and a product space;
   (ii) educt space inlet means for feeding at least one educt stream into the educt space, and product space outlet means for removing at least one product stream from the product space;
   (iii) a plurality of tubes extending, parallel to one another from the educt space to the product space according to (i), in an axial direction forming a tube bundle, wherein the tubes are at least partially filled with at least one heterogeneous catalyst;
   (iv) a cooling liquid space surrounding at least a section of the tube bundle according to (iii), wherein the cooling liquid space has a cooling liquid inlet and a cooling liquid outlet being spaced from the cooling liquid inlet at least in the axial direction, and wherein the cooling liquid space defines a cooling liquid flow path between the cooling liquid inlet and the cooling liquid outlet;
   (v) n temperature measuring devices MD(i), i=1 . . . n, n≥2, located inside the cooling liquid space, wherein MD(i+1), i<n, is located upstream of MD(i) in the cooling liquid flow path, for measuring the respective temperatures T(i) of the cooling liquid.
2. The chemical reactor of embodiment 1, wherein the cooling liquid space comprises m main sections MS(j), j=1 . . . m, m≥2, wherein in a main section MS(j), the cooling liquid has an average flow direction f(j), wherein f(j) is essentially perpendicular to the axial direction of the tube bundle.
3. The chemical reactor of embodiment 2, wherein the cooling liquid space further comprises k deflection sections DS(j), j=1 . . . k, wherein a deflection section DS(j) connects two adjacent main sections MS(j), wherein in a deflection section DS(j), the flow direction f(j) is deflected so that the flow direction f(j+1) is essentially opposite to f(j).
4. The chemical reactor of embodiment 3, wherein the flow path is unbranched and the cooling liquid space comprises m−1 deflection sections DS(j), j=1 . . . m−1, wherein a deflection section DS(j) connects two adjacent main sections MS(j) and MS(j+1), j<m.
5. The chemical reactor of embodiment 4, wherein n=m−1.
6. The chemical reactor of embodiment 3, wherein the flow path is branched and at least two main sections MS(j) and MS(j+1) are connected by a connecting section CS(j) being radially spaced from the deflection sections DS(j).
7. The chemical reactor of embodiment 6, wherein, if MS(j) and MS(j+1) are connected to each other by a connection section CS(j), they are not connected by a deflection section DS(j).
8. The chemical reactor of embodiment 7, wherein, if j is odd, MS(j) and MS(j+1) are connected to each other by a connection section CS(j) and wherein, if j is even, MS(j) and MS(j+1) are connected to each other by a deflection section DS(j−1).
9. The chemical reactor of any one of embodiments 6 to 8, wherein the deflection sections DS(j) are annular-shaped and the connection sections CS(j) are co-axially arranged in the center of the cooling liquid space.
10. The chemical reactor of any one of embodiments 2 to 9, wherein each temperature measuring device MD(i) is located in a deflection section DS(j).
11. The chemical reactor of any one of embodiments 2 to 10, wherein in each deflection section DS(j), a temperature measuring device MD(i) is located.
12. The chemical reactor of any one of embodiments 2 to 11, wherein 5≤m≤50, preferably wherein 5≤m≤20, more preferably 7≤m≤15
13. The chemical reactor of any one of embodiments 2 to 12, wherein the tube bundle according to (i) extends through the main sections MS(j).
14. The chemical reactor of any one of embodiments 2 to 13, wherein the tube bundle according to (i) does not extend through the deflection sections DS(j).
15. The chemical reactor of any one of embodiments 1 to 14, wherein the tube bundle extends between the educt space and the product space.
16. The chemical reactor of any of embodiments 1 to 15, wherein the tube bundle consists of from 50 to 100,000, preferably of from 500 to 50,000, more preferably of from 1,000 to 30,000 tubes.
17. The chemical reactor of any one of embodiments 1 to 16, wherein the axial direction according to (i) is an essentially vertical direction.
18. The chemical reactor of any one of embodiments 1 to 17, wherein the measurement of the respective temperatures T(i) of the cooling liquid is done simultaneously by the n temperature measuring devices MD(i) at least during subjecting the educt stream to exothermic reaction conditions in the tubes of the tube bundle obtaining a product stream, wherein the reaction conditions comprise contacting the educt stream with the heterogeneous catalyst with which the tubes of the tube bundles are at least partially filled, obtaining a set S(T(i)) of n temperatures T(i).
19. The chemical reactor of embodiment 18, wherein during subjecting the educt stream to exothermic reaction conditions, the temperature differences ΔT(i)=T(i)−T(i+1), i=1 . . . n−1, are calculated based on the temperatures T(i) measured, and wherein i is determined for which ΔT(i) exhibits its maximum, said i being defined as i(max).
20. The chemical reactor of embodiment 18 or 19, wherein at least during subjecting the at least one educt stream to exothermic reaction conditions the n temperatures T(i) of the cooling liquid are measured at consecutive times t(k), obtaining k temperatures T(i), Tₖ(i), k sets of the n temperatures T(i), Sₖ(T(i)), and, for each Sₖ(T(i)), a respective iₖ(max).
21. The chemical reactor of any one of embodiments 1 to 20 for use in the production of a chemical compound in an exothermic reaction.
22. The chemical reactor of embodiment 21, wherein the exothermic reaction is an oxidation or partial oxidation and the chemical compound is preferably acrolein, acrylic acid, phthalic acid anhydride, maleic acid anhydride, ethylene oxide, glyoxal or chlorine; a hydrogenation; or a chlorination and the chemical compound is preferably phosgene.
23. A chemical production unit comprising the chemical reactor according to any one of embodiments 1 to 22 and a temperature monitoring means for receiving and monitoring signals from the temperature measuring devices MD(i).
24. The chemical production unit of embodiment 23, wherein the temperature monitoring means further comprises a signal processing means and a calculating means.
25. A method for operating the chemical reactor according to any one of embodiments 1 to 22 or the chemical production unit according to embodiment 23 or 24, the method comprising
   (a) preparing a product stream in a heterogeneously catalyzed exothermic reaction, comprising
      (a.1) feeding an educt stream via the educt space inlet means according to (ii) into educt space according to (i) and into the tubes of the tube bundle according to (iii);
      (a.2) subjecting the educt stream to exothermic reaction conditions in the tubes of the tube bundle obtaining a product stream, the reaction conditions comprising contacting the educt stream with the heterogeneous catalyst with which the tubes of the tube bundles are at least partially filled;
      (a.3) removing the product stream from the educt space according to (i) via the product space outlet means according to (ii);
   (b) cooling, at least during subjecting the stream to exothermic reaction conditions according to (a.2), the tube bundle with a cooling liquid stream, said cooling comprising feeding the cooling liquid stream via the cooling liquid inlet into the cooling liquid space according to (iv), passing the cooling liquid stream through the cooling liquid space, and removing the cooling liquid stream from the cooling liquid space via the cooling liquid outlet according to (iv);
   (c) simultaneously measuring the n temperatures T(i) of the cooling liquid by means of each of the n temperature measuring devices MD(i) according to (v), at least during subjecting the educt stream to exothermic reaction conditions according to (a.2), obtaining a set S(T(i)) of n temperatures T(i).
26. The method of embodiment 25, further comprising, during subjecting the at least one educt stream to exothermic reaction conditions according to (a.2), calculating the temperature differences ΔT(i)=T(i)−T(i+1), i=1 . . . n−1, based on the temperatures T(i) measured according to (c), and determining i for which ΔT(i) exhibits its maximum, said i being defined as i(max), wherein said calculating is preferably carried out by the temperature monitoring means as defined in embodiment 23 or 24, preferably as defined in embodiment 24.
27. The method of embodiment 26, wherein at least during subjecting the at least one educt stream to exothermic reaction conditions according to (a.2), the n temperatures T(i) of the cooling liquid are measured at consecutive times t(k), obtaining k temperatures T(i), Tₖ(i), k sets of the n temperatures T(i), Sₖ(T(i)), and, for each Sₖ(T(i)), a respective iₖ(max).
28. The method of embodiment 27, further comprising determining iₖ(max) as a function of t(k).
29. The method of any one of embodiments 25 to 28, being a method for detecting the hotspot of a heterogeneously catalyzed exothermic reaction in a tube bundle reactor, preferably for determining the change of the position of the hotspot of a heterogeneously catalyzed exothermic reaction in a tube bundle reactor over time.
30. The method of embodiment 29, further being a method for tracking the deactivation of a heterogeneous catalyst in an exothermic reaction in the tubes of a tube bundle reactor.
31. Use of the chemical reactor according to any one of embodiments 1 to 22 or of the chemical production unit according to embodiment 23 or 24 or of the method according to any one of embodiments 25 to 30 for detecting the hotspot of a heterogeneously catalyzed exothermic reaction in a tube bundle reactor, preferably for determining the change of the position of the hotspot of a heterogeneously catalyzed exothermic reaction in a tube bundle reactor.
32. The use of embodiment 31 for tracking the deactivation of a heterogeneous catalyst in an exothermic reaction in the tubes of a tube bundle reactor.
33. The use of embodiment 30 or 31, wherein the measurement of the respective temperatures T(i) of the cooling liquid is done simultaneously by the n temperature measuring devices MD(i) according to (v), at least during subjecting the educt stream to exothermic reaction conditions in the tubes of the tube bundle obtaining a product stream, wherein the reaction conditions comprise contacting the educt stream with the heterogeneous catalyst with which the tubes of the tube bundles are at least partially filled, obtaining a set S(T(i)) of n temperatures T(i).
34. The use of any one of embodiments 30 to 33, wherein during subjecting the educt stream to exothermic reaction conditions, the temperature differences ΔT(i)=T(i)−T(i+1), i=1 . . . n−1, are calculated based on the temperatures T(i) measured, and wherein i is determined for which ΔT(i) exhibits its maximum, said i being defined as i(max), wherein said calculation is preferably carried out by the temperature monitoring means as defined in embodiment 23 or 24, preferably as defined in embodiment 24.
35. The use of any one of embodiments 30 to 34, wherein at least during subjecting the at least one educt stream to exothermic reaction conditions the n temperatures T(i) of the cooling liquid are measured at consecutive times t(k), obtaining k temperatures T(i), Tₖ(i), k sets of the n temperatures T(i), Sₖ(T(i)), and, for each Sₖ(T(i)), a respective iₖ(max).

The invention will now be further described by means of example embodiments in view of the figures. The figures show:

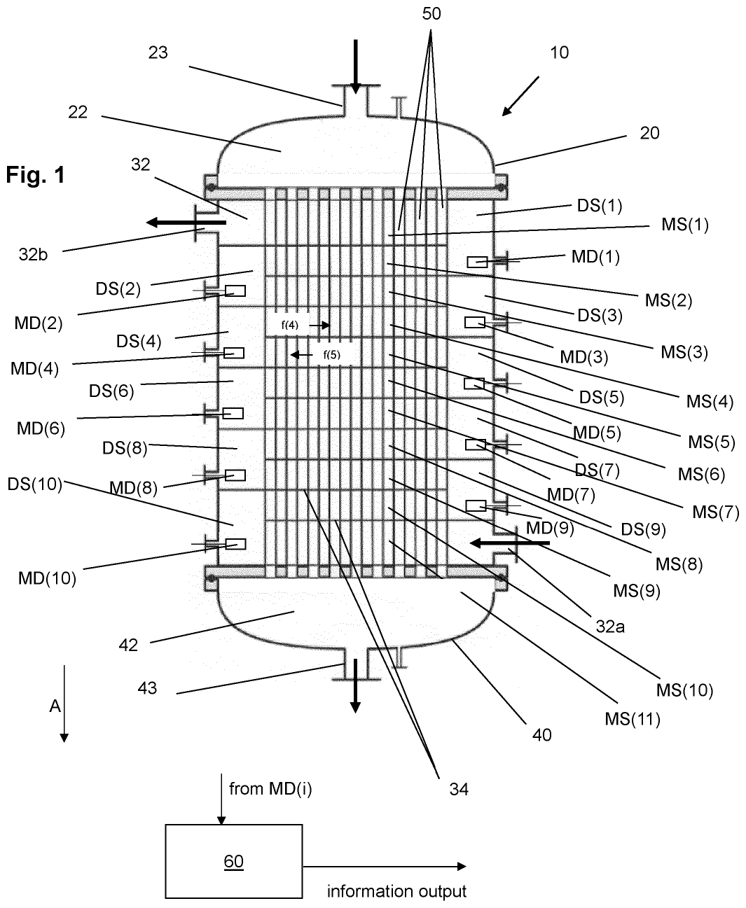

FIG. 1 a schematic representation of a first example embodiment of a reactor according to the invention and a temperature monitoring means

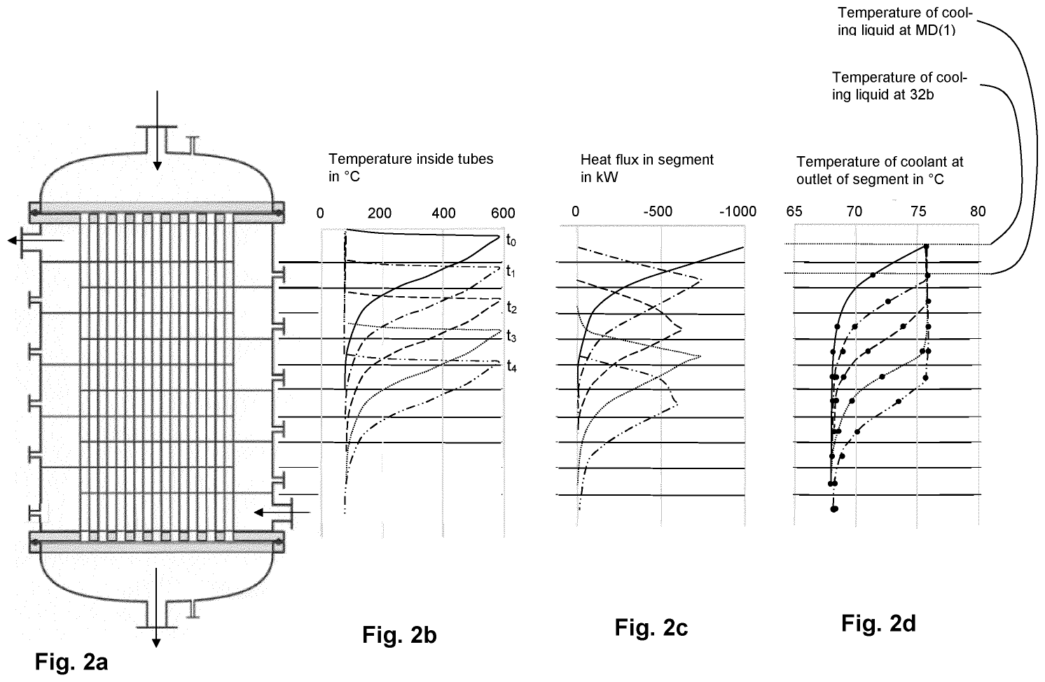

FIG. 2a again the reactor of FIG. 1

FIG. 2b the temperature profile inside the tubes of the bundle of tubes of the reactor shown in FIG. 2a measured at different times

FIG. 2c the heat flux in the main sections of the cooling liquid flow path (segments) of the reactor shown in FIG. 2a resulting from the temperature profiles shown in FIG. 2b

FIG. 2d the temperatures of the cooling liquid inside the reactor measured by means of the temperature measuring devices at four different times according to FIG. 2b

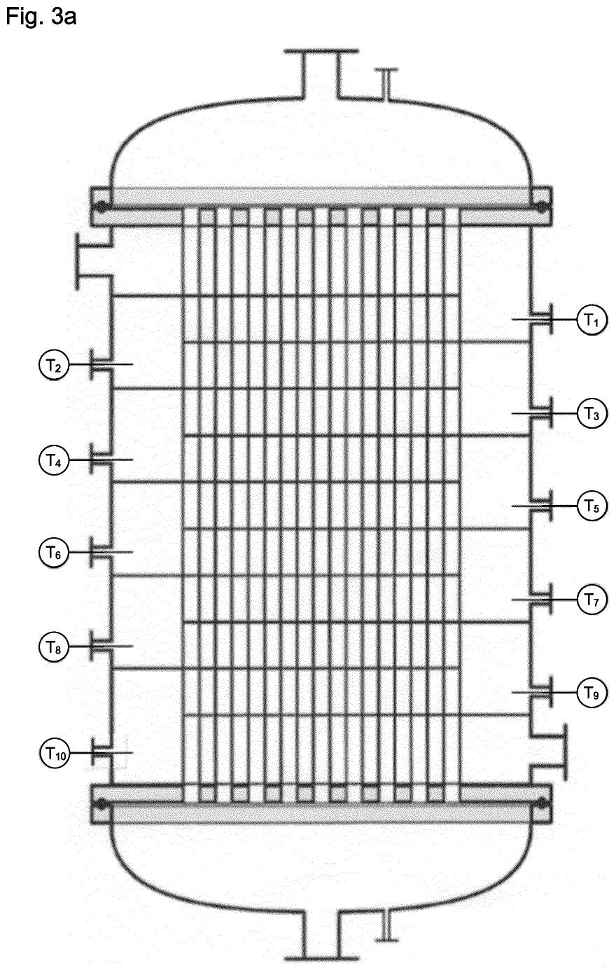

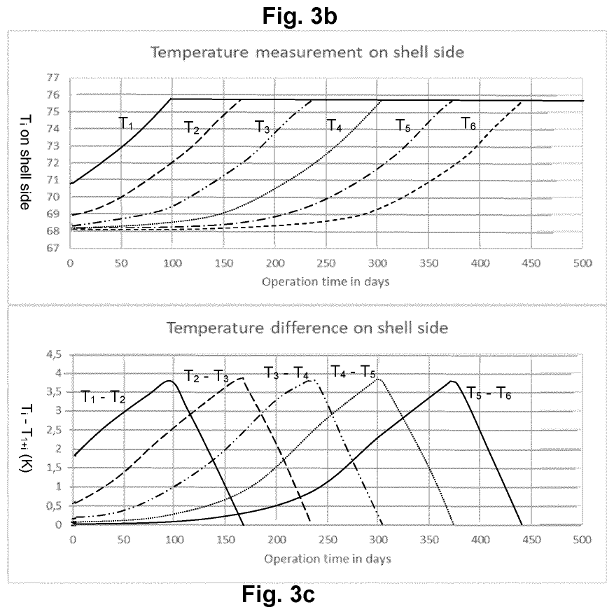

FIG. 3a again the reactor of FIG. 1

FIG. 3b a temperature-over-time diagram of the first six temperature measuring devices MD(1) . . . MD(6)

FIG. 3c the temperature differences between inlets and outlets of main sections of the cooling liquid space as a function of time

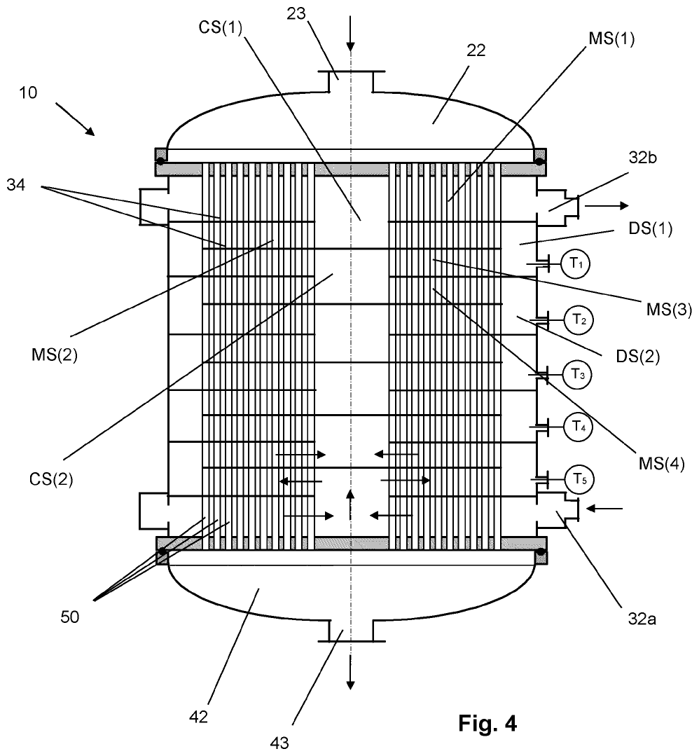

FIG. 4 a schematic representation of a second example embodiment of a reactor according to the invention

FIG. 1 shows an embodiment of a chemical production unit according to the invention. This chemical production unit comprises a chemical reactor 5 and a temperature monitoring means 60. As will be described later in detail this temperature monitoring means is adapted for receiving signals from temperature measuring devices being located inside the reactor 5. The temperature monitoring means 60 processes these signals and calculates results which it outputs via an information output. In the simplest case this information output could be a monitor. Of course, it is also possible that this information output is connected to a monitoring system of the chemical plant in which this production unit is installed.

The reactor 5 is essentially designed as the chemical reactor 5 described in generic WO03/072237 A1 and for details, reference is made to the respective disclosure in this document. The reactor 5 comprises an outer reactor structure 10 comprising an upper closure head 20, a lower closure head 40 and a middle section 30 located between the upper closure head 20 and the lower closure head 40. The middle section has an annular jacket 30a and two endplates 30b, 30c tightly connected to the annular jacket 30. The endplates comprise a congruent pattern of bores.

The upper end section 20 and the upper closure head 20 and the upper end plate 30b enclose an educt space 22 and the lower closure head 40 and the lower end plate 30c enclose a product space 42. The upper closure head can be removed from the middle section 30 but is tightly connected to the same in the operational state. The same applies to the lower closure head. The upper closure head 20 comprises an educt space inlet means in form of an educt inlet flange 23 and the lower closure head 40 comprises a product space outlet means in form of a product outlet flange 43.

A bundle of tubes 50 extends in an axial direction (which is in this case the vertical direction) from the upper end plate 30b to the lower end plate 30c in such a way that the bores in the end plate align with the tubes, such that the educt space 22 is connected to the product space 42 by means of the insides of these tubes 15. Of course, the tubes 50 are tightly connected to the end plates 30b, 30c. In the state of operation the tubes 50 of bundle of tubes are filled with a heterogeneous catalyst, which can for example be a catalyst as described hereinabove. When filling the tubes with catalyst, the upper closure head 20 is removed.

Because of the above described structure, the middle section 30 defines a cooling liquid space 32 through which the bundle to tubes 50 extends. This cooling liquid space 32 has a cooling liquid inlet 32a and a cooling liquid outlet 32b. In the embodiment shown, the cooling liquid inlet is located at the lower end of the middle section 30 (near the product space 42) and the cooling liquid outlet is located at the upper end of the middle section 30 near the educt space 22. Thus, a counterstream-cooling-configuration is given, but it should be noted that a counterstream-configuration is not a mandatory feature of the invention.

The cooling liquid space 30 is divided into a plurality—in the example embodiment shown into 11—main sections MS (1) to MS (11) by means of baffles 34. These baffles 34 extend perpendicular to the tubes 50, thus perpendicular to the axial direction A. The tubes 50 extend through these baffles 34 in the main sections MS(j). Usually it is not necessary to connect the tubes 50 to the baffles 34. It is preferred that there is a small opening, especially an annular opening between each tube and each baffle. These openings each allow a small bypass flow.

Adjacent main sections MS(j) and MS(j+1) are connected to one another by means of one deflection section DS(j) in which the baffle 34 dividing the two main sections MS(j) from one another has an opening. DS(j+1) is radially opposed from DS(j) such that a meander-type cooling liquid flow path results such that the average main flow direction f(j) in a main section MS(j) is essentially opposite the average main flow direction f(j+1) in the adjacent main section MS(j+1). In this embodiment and according to the definitions chosen herein, the flow path extends from the main section MS(11) to main section MS(1).

Temperature measuring devices MD(1) to MD(10) are provided in the deflection sections DS(1) to DS(10). Additionally, although not shown, a measuring device can be provided at or near the cooling liquid outlet 32b. Since the cooling liquid flows from the cooling liquid inlet 32a to the cooling liquid outlet 32b such that the temperature measuring device MD(9) is downstream of temperature measuring device in DS(10) and so on, each temperature measuring device MD(i) measures the outlet temperature of the main section MS(i+1) (for example the temperature measuring device in MD(5) measures the temperature of the cooling liquid after it has passed the main section MS(6)) and the temperature difference T(MD(i))−T(MD(i+1)) is the temperature gain of cooling liquid passing through the main section MS(i).

The measuring devices MD(i) feed their information—which are signal representing the measured temperature—to the temperature monitoring device 60.

FIG. 2b shows the axial temperature profile inside the tubes at different points in time t₀ to t₄ with to being close to the start of a new production cycle with new or refreshed catalyst and t₀<t₁<t₂<t₃<t₄. One sees that inside the tubes there is a distinct hotspot such that the temperature rises steeply when approaching in axial direction from the educt space side and then decreases slowly due to the cooling by the cooling liquid. This means that most of the reaction takes place in a rather small zone where the reaction heat is generated, such that this zone (hotspot) is relatively hot—here about 600° C. The reaction products leave this hotspot essentially with the same temperature as the hotspot itself thus heating the tubes even downstream of the tubes. Because of the cooling with the cooling liquid, the temperature decreases with increasing distance from the hotspot in axial direction. Upstream from the hotspot the inside of the tubes remain relatively cool since most of the heat is transported by the hot product gas. Of course there is some heat transfer in the direction towards the educt space due to heat conduction of the tubes 50 themselves.

Taken the above into account one can easily see from FIG. 2b how the hotspot moves towards the product space side with time. This is caused by the deactivation of the catalyst inside the tubes 50. So, the information that can be derived from FIG. 2b is sufficient in order to know the position of the hotspot and its velocity when moving from the educt-side end of the tubes to the product-side end of the tubes.

As one will now see in view of FIGS. 2c, 2c, 3c and 3c, the position of the hotspot can (at least roughly) be also detected by interpreting the temperatures of the cooling liquid measured by the temperature measuring device MD(i):

From FIG. 2c one sees the heat flux per main section MS(j) (here referred to as “segment”) at the same points in time as in FIG. 2b (the solid line represents the time to, the line with the pattern dot-dash-dot represents the time t₁ and so on). One sees that the maximum of the heat flux is a little stream downwards (in view of the educt-product gas stream) but correlates with the position of the hotspot.

FIG. 2d shows directly the measured temperatures of the cooling liquid (here referred to as “coolant”) at the outlet of the main sections MS(j) (“segments”) meaning inside the deflection sections DS(j−1). It is to be noted that the upper main section in the diagram 2d is the first main section MS(1). The line patterns are the same as in FIGS. 2b and 2c. One sees that the temperature rises in the flow direction of the cooling liquid from segment to segment but the rise comes to a halt when the segment of the maximum heat flux (FIG. 2c) is reached. Thus, the segment from which one the temperature does not rise any longer, is the segment with the maximum heat flux and by comparison with FIG. 2b one can at least approximately determine the position of the hotspot.

FIG. 3b also shows the temperatures measured by temperature measuring devices MD(i), namely the temperature measuring devices MD(1) to MD(6) but as a function of operation time. The result is of course the same as can be deduced from FIG. 2d: The temperature rises approximately until the hotspot has passed by. The same can be expressed in calculating the temperature differences of two temperature measuring devices MS(j), MS(j−1).

As can be seen from FIG. 4, the invention can also be applied to reactors of the radial type. Here, the cooling liquid inlet 32a and the cooling liquid outlet 32b are both ring-shaped. As in the first embodiment, a counterstream configuration is shown but again this is not a mandatory feature. Starting from the cooling liquid inlet 32b, the cooling liquid streams through the first main section MS(1) radially inward to a first connection section CS(1) which connects the first main section MS(1) to the second main section MS(2). At the position of this connection section the baffle 34 dividing the first main section MS(1) from the second main section MS(2) has a hole. Following the first connection section CS(1) the cooling liquid streams radially outward until it reaches the first deflection section CS(1) there it is deflected radially inward to the third main section MS(3) and so on.

As in the first embodiment, the temperature monitoring means 60 are located in the deflection sections DS(1) and the measurement principle is as described above in connection with the first embodiment, but the spatial resolution of the temperature measurement is lower, since compared to the first embodiment, every second deflection section is replaced by a connection section. Of course, it would be possible (but it is usually not necessary) to reach the same spatial resolution as in the first embodiment by placing temperature measuring means 60 also in the connection sections.

One sees that the position and thus also the velocity of the axial movement of the hotspot can be determined only by performing simple measurements of the temperature of the cooling liquid.

### LIST OF REFERENCE NUMBERS

10 reactor vessel
20 upper end section
21 upper dividing plate
22 educt space
23 educt space inlet means (educt inlet flange)
30 middle section
32 cooling liquid space
32a cooling liquid inlet
32b cooling liquid outlet
MS(j) main section
DS(j) deflection section
CS(j) connection section
34 baffle
40 lower end section
41 lower dividing plate
42 product space
43 product space outlet means (product outlet flange)
50 tube
60 temperature monitoring means
MD(i) temperature measuring device
A(i) access for temperature measuring device

### CITED LITERATURE

WO03/072237 A1

1.-16. (canceled)

17. A chemical reactor comprising (i) an educt space and a product space;
(ii) educt space inlet means for feeding at least one educt stream into the educt space, and product space outlet means for removing at least one product stream from the product space;
(iii) a plurality of tubes extending, parallel to one another from the educt space to the product space according to (i), in an axial direction forming a tube bundle, wherein the tubes are at least partially filled with a heterogeneous catalyst;
(iv) a cooling liquid space surrounding at least a section of the tube bundle according to (iii), wherein the cooling liquid space has a cooling liquid inlet and a cooling liquid outlet being spaced from the cooling liquid inlet at least in the axial direction, and wherein the cooling liquid space defines a cooling liquid flow path between the cooling liquid inlet and the cooling liquid outlet;
(v) n temperature measuring devices MD(i), i=1 . . . n, n>2, located inside the cooling liquid space, wherein MD(i+1), i<n, is located upstream of MD(i) in the cooling liquid flow path, for measuring the respective temperatures T(i) of the cooling liquid.

18. The chemical reactor of claim 17, wherein the cooling liquid space comprises m main sections MS(j), j=1 . . . m, m≥2, wherein in a main section MS(j), the cooling liquid has an average flow direction f(j), wherein f(j) is essentially perpendicular to the axial direction of the tube bundle, and wherein the cooling liquid space further comprises m−1 deflection sections DS(j), j=1 . . . m−1, wherein a deflection section DS(j) connects two adjacent main sections MS(j) and MS(j+1), j<m, wherein in a deflection section DS(j), the flow direction f(j) is deflected so that the flow direction f(j+1) is essentially opposite to f(j).

19. The chemical reactor of claim 18, wherein each temperature measuring device MD(i) is located in a deflection section DS(j).

20. The chemical reactor of claim 18, wherein the tube bundle according to (i) extends through the main sections MS(j).

21. The chemical reactor of claim 17, wherein the axial direction according to (i) is an essentially vertical direction.

22. The chemical reactor of claim 17, wherein the measurement of the respective temperatures T(i) of the cooling liquid is done simultaneously by the n temperature measuring devices MD(i) at least during subjecting the educt stream to exothermic reaction conditions in the tubes of the tube bundle obtaining a product stream, wherein the reaction conditions comprise contacting the educt stream with the heterogeneous catalyst with which the tubes of the tube bundles are at least partially filled, obtaining a set S(T(i)) of n temperatures T(i), wherein during subjecting the educt stream to exothermic reaction conditions, the temperature differences ΔT(i)=T(i)−T(i+1), i=1 . . . n−1, are calculated based on the temperatures T(i) measured, and wherein i is determined for which ΔT(i) exhibits its maximum, said i being defined as i(max), and
wherein at least during subjecting the at least one educt stream to exothermic reaction conditions the n temperatures T(i) of the cooling liquid are measured at consecutive times t(k), obtaining k temperatures T(i), Tₖ(i), k sets of the n temperatures T(i), Sₖ(T(i)), and, for each Sₖ(T(i)), a respective iₖ(max).

23. A method for producing a chemical compound in an exothermic reaction, a hydrogenation reaction, or a chlorination reaction comprising the chemical reactor of claim 17.

24. A chemical production unit comprising the chemical reactor of claim 17 and a temperature monitoring means for receiving and monitoring signals from the temperature measuring devices MD(i).

25. The chemical production unit of claim 24, wherein the temperature monitoring means further comprises a signal processing means and a calculating means.

26. A method for operating the chemical reactor according to claim 17, the method comprising
(a) preparing a product stream in a heterogeneously catalyzed exothermic reaction, comprising
(a.1) feeding an educt stream via the educt space inlet means according to (ii) into educt space according to (i) and into the tubes of the tube bundle according to (iii);
(a.2) subjecting the educt stream to exothermic reaction conditions in the tubes of the tube bundle obtaining a product stream, the reaction conditions comprising contacting the educt stream with the heterogeneous catalyst with which the tubes of the tube bundles are at least partially filled;
(a.3) removing the product stream from the educt space according to (i) via the product space outlet means according to (ii);
(b) cooling, at least during subjecting the stream to exothermic reaction conditions according to (a.2), the tube bundle with a cooling liquid stream, said cooling comprising feeding the cooling liquid stream via the cooling liquid inlet into the cooling liquid space according to (iv), passing the cooling liquid stream through the cooling liquid space, and removing the cooling liquid stream from the cooling liquid space via the cooling liquid outlet according to (iv);
(c) simultaneously measuring the n temperatures T(i) of the cooling liquid by means of each of the n temperature measuring devices MD(i) according to (v), at least during subjecting the educt stream to exothermic reaction conditions according to (a.2), obtaining a set S(T(i)) of n temperatures T(i).

27. The method of claim 26, further comprising, during subjecting the at least one educt stream to exothermic reaction conditions according to (a.2), calculating the temperature differences ΔT(i)=T(i)−T(i+1), i=1 . . . n−1, based on the temperatures T(i) measured according to (c), and determining i for which ΔT(i) exhibits its maximum, said i being defined as i(max).

28. The method of claim 27, wherein at least during subjecting the at least one educt stream to exothermic reaction conditions according to (a.2), the n temperatures T(i) of the cooling liquid are measured at consecutive times t(k), obtaining k temperatures T(i), Tₖ(i), k sets of the n temperatures T(i), Sₖ(T(i)), and, for each Sₖ(T(i)), a respective iₖ(max).

29. A method detecting the hotspot of a heterogeneously catalyzed exothermic reaction in a tube bundle reactor, the method comprising the method according to claim 26.

30. The method of claim 29, wherein the method further comprises tracking the deactivation of a heterogeneous catalyst in an exothermic reaction in the tubes of a tube bundle reactor.

31. A method for detecting the hotspot of a heterogeneously catalyzed exothermic reaction in a tube bundle reactor comprising the reactor according to claim 17.

32. A method for tracking the deactivation of a heterogeneous catalyst in an exothermic reaction in the tubes of a tube bundle reactor comprising the method of claim 31.
